(19) United States
(12) Patent Application Publication
(10) Pub. No.: US 2026/0260249 A1
(43) Pub. Date: Sep. 3, 2026

(54) METHOD AND SYSTEM FOR PERFORMING COMPLIANCE REVIEWS

(71) Applicant: JPMorgan Chase Bank, N.A., New York, NY (US)

(72) Inventors: James MASSA, Water Mill, NY (US); Nithya SUBBARAMAN, Bangalore (IN); Viraaji MOTHUKURI, Smyrna, GA (US); Narender RAJAPUTHRA, Belle Mead, NJ (US); Mitali BASAK, Parsippany, NJ (US); Akash BAJAJ, West New York, NJ (US)

(73) Assignee: JPMorgan Chase Bank, N.A., New York, NY (US)

(21) Appl. No.: 19/180,651

(22) Filed: Apr. 16, 2025

(30) Foreign Application Priority Data
Mar. 3, 2025 (IN) 202511018499

(51) Int. Cl. G06Q 30/018

(52) U.S. Cl. CPC G06Q 30/018

(57) ABSTRACT

A method and a system for performing compliance reviews are provided. The method includes: receiving at least one training document; generating a document graph by executing prompts against a commercial model, from multiple teacher perspectives, on the training document; training a local model based on the document graph using LLM distillation; receiving a first document for which compliance testing is requested; analyzing, via the local model, the first document for compliance issues; and generating a second output based on a result of the analyzing. The second output includes a compliance result of the first document and an explanation of the compliance result. Each prompt represents a selected respective perspective. Each prompt includes a respective selection of documents. The execution of each respective prompt generates a respective first output that is used as an input for the document graph.

### CROSS-REFERENCE TO RELATED APPLICATIONS

This application claims priority benefit from Indian Application No. 202511018499, filed on Mar. 3, 2025 in the India Patent Office, which is hereby incorporated by reference in its entirety.

### BACKGROUND

### 1. Field of the Disclosure

This disclosure generally relates to methods and systems for performing compliance reviews, and more particularly to methods and systems for generating a local model to assess compliance issues of provided documents and to provide a comprehensive explanation of the assessment.

### 2. Background Information

Every word of every sentence of text and media that banks or financial institutions publish or provide to the public need to be checked for thousands of different issues related to various different compliance regulations, policies, and procedures. For example, a document that is sent out by a banking institution should not guarantee performance. Therefore, every sentence of every document that is publicly released by a financial institution needs to be analyzed to ensure that nothing explicitly says or can reasonably be construed as guaranteeing performance. This is an extremely difficult and time-consuming process.

Currently, commercial artificial intelligence (AI) models (e.g., ChatGPT, etc.) can be used to check for compliance issues. For example, a document may be provided to the commercial model, and the model may be asked to determine whether there is a compliance issue. However, this process is generalized, slow, and expensive. Particularly, each compliance check using a commercial model requires an application programming interface (API) call that costs money. Additionally, because commercial models are continually being tuned, changed, and/or updated, results may change depending on when the model is run, thus providing inconsistent and unreliable results.

Accordingly, there is a need for a system that generates a model for assessing compliance issues of provided documents and that provides a comprehensive explanation of the assessment. Particularly, the model should reduce the processing cost of automatically reviewing text and media for compliance purposes. Moreover, the model should be specialized for document compliance and thus should be more performant, reliable, and economical for its use case. Additionally, the model should be able to not only identify non-compliant text, but should also identify the reasons the text is non-compliant, as well provide suggested fixes to the text.

### SUMMARY

The present disclosure, through one or more of its various aspects, embodiments, and/or specific features or sub-components, provides, inter alia, various systems, servers, devices, methods, media, programs, and platforms for generating a local model to assess compliance issues of provided documents and to provide a comprehensive explanation of the assessment.

According to an aspect of the present disclosure, a method for performing compliance reviews is provided. The method may be implemented by at least one processor. The method may include: receiving, by the at least one processor, at least one training document; generating, by the at least one processor, a document graph that includes compliance issues and text fixes for the compliance issues by executing a plurality of prompts within a commercial model on the training document; training, by the at least one processor, a local model based on the document graph; receiving, by the at least one processor, a first document for which compliance testing is requested; analyzing, by the at least one processor via the local model, the first document for compliance issues; and generating, by the at least one processor, a second output based on a result of the analyzing. Each prompt of the plurality of prompts may represent a respective perspective selected from among a plurality of perspectives. Each prompt may include a respective selection of documents from among a plurality of documents. The execution of each respective prompt may generate a respective first output that is used as an input for the document graph. The second output may include at least one from among a compliance result of the first document, an explanation of the compliance result, and a fix for an identified compliance issue.

The plurality of perspectives may include at least one from among a compliance officer perspective, a marketing officer perspective, a regulator perspective, and a client perspective, and the training of the local model uses large language model (LLM) distillation.

The plurality of documents may include at least one from among a compliance policy, a compliance procedure manual, an audit report, a marketing document guideline, a marketing procedure manual, a marketing training manual, a regulations document, a regulator findings document, a client complaint, a client account disclosure, a compliance taxonomy, a marketing taxonomy, a regulator taxonomy, and a client taxonomy.

The respective first output may include at least one from among a flagged text that represents a potential compliance issue, an explanation of what is non-compliant about the flagged text, a proposed copy edit to make the flagged text compliant, an explanation of the proposed copy edit, and a proposed next step to be taken.

The method may further include training, by the at least one processor, the local model on organization-specific data.

The analyzing of the first document may include: separating, by the at least one processor, the first document into at least one sub-document chunk having a predetermined number of words; generating, by the at least one processor via a LLM, a respective embedding for each respective sub-document chunk of the at least one sub-document chunk; transmitting, by the at least one processor, each respective embedding to a vector database; and identifying, by the at least one processor via a natural language processing (NLP) and the local model, non-compliant phrases within each respective embedding in the vector database.

The method may further include categorizing, by the at least one processor, the compliance result of the first document as being at least one from among a true compliance issue, a non-issue, and an undetermined result; and when the compliance result is categorized as being the undetermined result, analyzing, by the at least one processor via the commercial model, the first document for compliance issues.

The method may further include determining, by the at least one processor via a machine learning algorithm, whether there is an anomaly in a performance of the local model; and triggering, by the at least one processor, a tuning of the local model based on a result of the determining.

The method may further include performing, by the at least one processor, a return on investment (ROI) analysis for the local model. The performing of the ROI analysis may include determining a performance metric value and a cost-benefit metric value. The triggering of the tuning may be further based on a result of the ROI analysis.

According to another aspect of the present disclosure, a computing apparatus for performing compliance reviews is provided. The computing apparatus may include a processor; a memory; and a communication interface coupled to each of the processor, and the memory. The processor may be configured to: receive at least one training document; generate a document graph that includes compliance issues and text fixes for the compliance issues by executing a plurality of prompts within a commercial model on the training document; train a local model based on the document graph; receive a first document for which compliance testing is requested; analyze, via the local model, the first document for compliance issues; and generate a second output based on a result of the analyzing. Each prompt of the plurality of prompts may represent a respective perspective selected from among a plurality of perspectives. Each prompt may include a respective selection of documents from among a plurality of documents. The execution of each respective prompt may generate a respective first output that is used as an input for the document graph. The second output may include at least one from among a compliance result of the first document, an explanation of the compliance result, and a fix for an identified compliance issue.

The plurality of perspectives may include at least one from among a compliance officer perspective, a marketing officer perspective, a regulator perspective, and a client perspective, and the training of the local model uses LLM distillation.

The plurality of documents may include at least one from among a compliance policy, a compliance procedure manual, an audit report, a marketing document guideline, a marketing procedure manual, a marketing training manual, a regulations document, a regulator findings document, a client complaint, a client account disclosure, a compliance taxonomy, a marketing taxonomy, a regulator taxonomy, and a client taxonomy.

The respective first output includes at least one from among a flagged text that represents a potential compliance issue, an explanation of what is non-compliant about the flagged text, a proposed copy edit to make the flagged text compliant, an explanation of the proposed copy edit, and a proposed next step to be taken.

The processor may be further configured to train the local model on organization-specific data.

The processor may be further configured to perform the analyzing of the first document by: separating the first document into at least one sub-document chunk having a predetermined number of words; generating, via an LLM, a respective embedding for each respective sub-document chunk of the at least one sub-document chunk; transmitting each respective embedding to a vector database; and identifying, via an NLP and the local model, non-compliant phrases within each respective embedding in the vector database.

The processor may be further configured to: categorize the compliance result of the first document as being at least one from among a true compliance issue, a non-issue, and an undetermined result; and when the compliance result is categorized as being the undetermined result, analyze, via the commercial model, the first document for compliance issues.

The processor may be further configured to: determine, via a machine learning algorithm, whether there is an anomaly in a performance of the local model; and trigger a tuning of the local model based on a result of the determination.

The processor may be further configured to: perform an ROI analysis for the local model, wherein the performing of the ROI analysis includes determining a performance metric value and a cost-benefit metric value, and wherein the triggering of the tuning is further based on a result of the ROI analysis.

According to yet another aspect of the present disclosure, a non-transitory computer readable storage medium storing instructions for performing compliance reviews is provided. The storage medium includes executable code which, when executed by a processor, may cause the processor to: receive at least one training document; generate a document graph that includes compliance issues and text fixes for the compliance issues by executing a plurality of prompts within a commercial model on the training document; train a local model based on the document graph; receive a first document for which compliance testing is requested; analyze, via the local model, the first document for compliance issues; and generate a second output based on a result of the analyzing. Each prompt of the plurality of prompts may represent a respective perspective selected from among a plurality of perspectives. Each prompt may include a respective selection of documents from among a plurality of documents. The execution of each respective prompt may generate a respective first output that is used as an input for the document graph. The second output may include at least one from among a compliance result of the first document, an explanation of the compliance result, and a fix for an identified compliance issue.

The plurality of perspectives may include at least one from among a compliance officer perspective, a marketing officer perspective, a regulator perspective, and a client perspective, and the training of the local model uses LLM distillation.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for generating a local model to assess compliance issues of provided documents and to provide a comprehensive explanation of the assessment, according to an embodiment.

FIG. 2 illustrates a diagram of a network environment for generating a local model to assess compliance issues of provided documents and to provide a comprehensive explanation of the assessment, according to an embodiment.

FIG. 3 illustrates a system diagram of a system for generating a local model to assess compliance issues of provided documents and to provide a comprehensive explanation of the assessment, according to an embodiment.

FIG. 4 illustrates a process diagram of a process for generating a local model to assess compliance issues of provided documents and to provide a comprehensive explanation of the assessment, according to an embodiment.

FIG. 5 illustrates a system diagram for generating a local model to assess compliance issues of provided documents and to provide a comprehensive explanation of the assessment, according to an embodiment.

FIG. 6 illustrates a flow diagram of a process for generating a local model to assess compliance issues of provided documents and to provide a comprehensive explanation of the assessment, according to an embodiment.

FIG. 7 illustrates a flow diagram of a process for generating a local model to assess compliance issues of provided documents and to provide a comprehensive explanation of the assessment, according to an embodiment.

FIG. 8 illustrates a flow diagram of a process for generating a local model to assess compliance issues of provided documents and to provide a comprehensive explanation of the assessment, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein analyzes documents to perform compliance reviews. Particularly, the system may receive or access a training document. The system may then execute a plurality of prompts in a commercial AI model to analyze the training document. The plurality of prompts may relate to various perspectives, standards, policies, and/or compliance checks for assessing the training document's compliance. The system may then compile each of the results from the commercial model into a document graph. Next, the system may use the document graph to train a local or in-house AI model. Once, the local AI model is trained, the system may receive and analyze a document for compliance issues. The local model's results may be based solely on the specific perspectives, standards, and/or policies used for generating the document graph. The system may then output the compliance result and an explanation of the compliance result.

By using a local model trained from the results of a commercial model that was fed various pre-determined perspectives, standards, and/or policies, the system can analyze compliance issues from only these specific perspectives, standards, and/or policies. The use of this trained local model produces low-cost/free results that are more accurate than commercial models. Particularly, the system makes innovative use of a multi-agent model paradigm to create an annotated document graph that contains non-compliant text, the reasons the text is non-compliant, and suggested fixes to the text. The annotated document graph may be used to fine tune an open-source model that runs locally, without a pricey call to a commercial LLM's API. This local model achieves compliance at low cost and improves performance, accuracy, and reliability. Additionally, the system may find the issues faster because the model runs locally without the latency or the dollar cost of API calls. Furthermore, because the local model is fully controlled by the system, it is stable and reliable, such that there is no third party tuning the weights of the LLM. And the system is more reliable than current technology because the local model's results remain constant whereas current solutions rely on frontier models whose results change whenever the provider tunes the model weights. All this makes system better than the other document processing products. Moreover, the system may provide a technical improvement by determining underlying risks associated with an AI model, such that the particular AI model may be altered or improved so as to prevent potential issues or security risks.

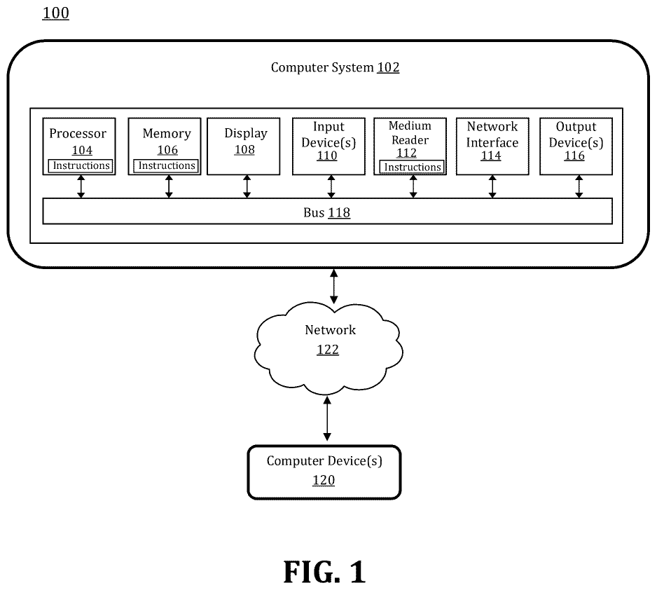

FIG. 1 is a system 100 for generating a local model to assess compliance issues of provided documents and to provide a comprehensive explanation of the assessment, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the compliance review module implemented by the system 100 may allow for generating of a local model to assess compliance issues of provided documents and providing a comprehensive explanation of the assessment. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

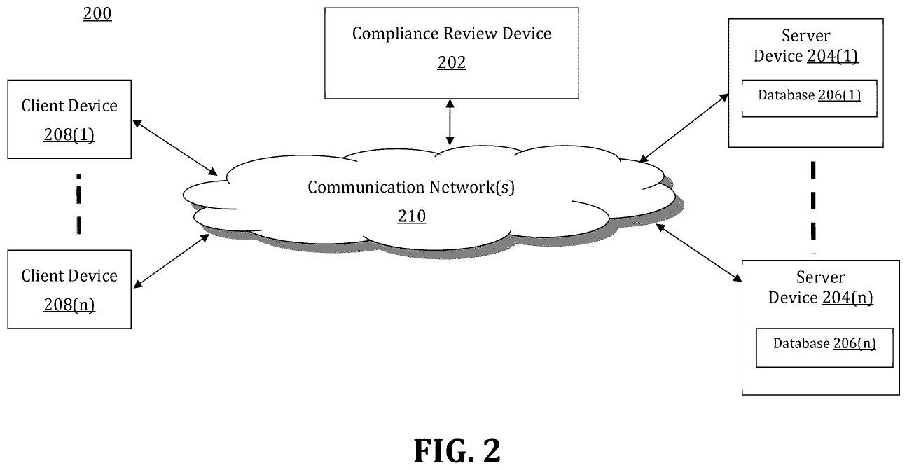

Referring to FIG. 2, a schematic of a network environment 200 for generating a local model to assess compliance issues of provided documents and to provide a comprehensive explanation of the assessment is illustrated.

In some embodiments, the above-described problems associated with conventional tools may be overcome by implementing a compliance review device 202 as illustrated in FIG. 2 that may be configured for generating a local model to assess compliance issues of provided documents and to provide a comprehensive explanation of the assessment, but the disclosure is not limited thereto.

The compliance review device 202 may include one or more computer systems 102, as described with respect to FIG. 1, which in aggregate provide the necessary functions.

The compliance review device 202 may store one or more applications that can include executable instructions that, when executed by the compliance review device 202, cause the compliance review device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the compliance review device 202 itself, may be located in virtual server(s) running in a cloud-based computing environment rather than being tied to one or more specific physical network computing devices. Also, the application(s) may be running in one or more virtual machines (VMs) executing on the compliance review device 202. Additionally, in one or more embodiments of this technology, virtual machine(s) running on the compliance review device 202 may be managed or supervised by a hypervisor.

In the network environment 200 of FIG. 2, the compliance review device 202 may be coupled to a plurality of server devices 204(1)-204(n) that hosts a plurality of databases 206(1)-206(n), and also to a plurality of client devices 208(1)-208(n) via communication network(s) 210. A communication interface of the compliance review device 202, such as the network interface 114 of the computer system 102 of FIG. 1, operatively couples and communicates between the compliance review device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the compliance review device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The compliance review device 202 may be a standalone device or integrated with one or more other devices or apparatuses, such as one or more of the server devices 204(1)-204(n), for example. In one example, the compliance review device 202 may be hosted by one of the server devices 204(1)-204(n), and other arrangements are also possible. Moreover, one or more of the devices of the compliance review device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the compliance review device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the compliance review device 202 that may generate a local model to assess compliance issues of provided documents and to provide a comprehensive explanation of the assessment, but the disclosure is not limited thereto.

The client devices 208(1)-208(n) may run interface applications, such as standard web browsers or standalone client applications, which may provide an interface to communicate with the compliance review device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the compliance review device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the compliance review device 202, the server devices 204(1)-204(n), or the client devices 208(1)-208(n), for example, may be configured to operate as virtual instances on the same physical machine. For example, one or more of the compliance review devices 202, the server devices 204(1)-204(n), or the client devices 208(1)-208(n) may operate on the same physical device rather than as separate devices communicating through communication network(s) 210. Additionally, there may be more or fewer compliance review devices 202, server devices 204(1)-204(n), or client devices 208(1)-208(n) than illustrated in FIG. 2. In some embodiments, the compliance review device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

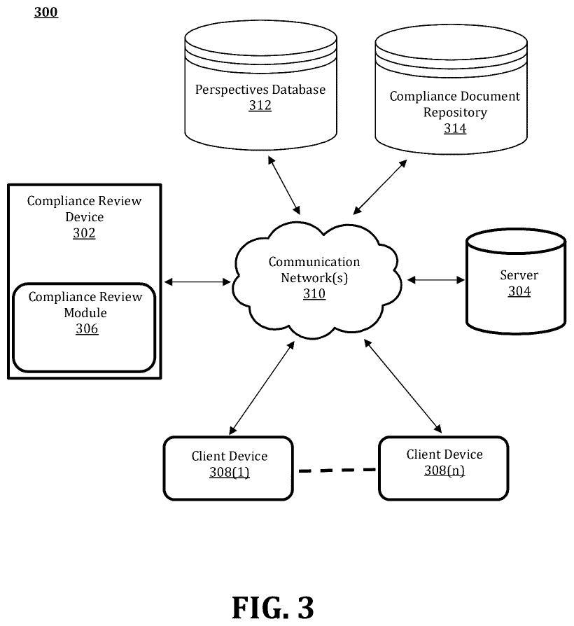

FIG. 3 illustrates a system diagram for generating a local model to assess compliance issues of provided documents and to provide a comprehensive explanation of the assessment, in accordance with an embodiment.

As illustrated in FIG. 3, the system 300 may include a compliance review device 302 within which a compliance review module 306 is embedded, a server 304, a perspectives database 312, a compliance document repository 314, a plurality of client devices 308(1) . . . 308(n), and a communication network 310.

In some embodiments, the compliance review device 302 including the compliance review module 306 may be connected to the server 304, the perspectives database 312, and the compliance document repository 314 via the communication network 310. The compliance review device 302 may also be connected to the plurality of client devices 308(1) 308(n) via the communication network 310, but the disclosure is not limited thereto. The perspectives database 312 and the compliance document repository 314 may include one or more repositories or databases.

In an embodiment, the compliance review device 302 is described and shown in FIG. 3 as including the compliance review module 306, although it may include other rules, policies, modules, databases, or applications, for example. In some embodiments, the perspectives database 312 and the compliance document repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the perspectives database 312 and the compliance document repository 314 may be a mainframe database, a log database that may produce programming for searching, monitoring, and analyzing machine-generated data via a web interface, but the disclosure is not limited thereto. In addition, the perspectives database 312 and the compliance document repository 314 may store a plurality of data sets and predictive models for identifying compliance issues.

In some embodiments, the compliance review module 306 may be configured to receive a real-time feed of data from the plurality of client devices 308(1) . . . 308(n) and secondary sources via the communication network 310.

The compliance review module 306 may be configured to: receive at least one training document; generate a document graph by executing a plurality of prompts within a commercial model on the training document, wherein each prompt of the plurality of prompts represents a respective perspective selected from among a plurality of perspectives, wherein each prompt includes a respective selection of documents from among a plurality of documents, and wherein the execution of each respective prompt generates a respective first output that is used as an input for the document graph; train a local model based on the document graph; receive a first document for which compliance testing is requested; analyze, via the local model, the first document for compliance issues; and generate a second output based on a result of the analyzing, wherein the second output includes a compliance result of the first document and an explanation of the compliance result.

The plurality of client devices 308(1) . . . 308(n) are illustrated as being in communication with the compliance review device 302. In this regard, the plurality of client devices 308(1) . . . 308(n) may be “clients” (e.g., customers) of the compliance review device 302 and are described herein as such. Nevertheless, it is to be known and understood that the plurality of client devices 308(1) . . . 308(n) need not necessarily be “clients” of the compliance review device 302, or any entity described in association therewith herein. Any additional or alternative relationship may exist between either or both plurality of client devices 308(1) . . . 308(n) and the compliance review device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the compliance review device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The compliance review device 302 may be the same or similar to the compliance review device 202 as described with respect to FIG. 2, including any features or combination of features described with respect thereto.

Upon being started, the compliance review device 302 executes a process for generating a local model to assess compliance issues of provided documents and to provide a comprehensive explanation of the assessment.

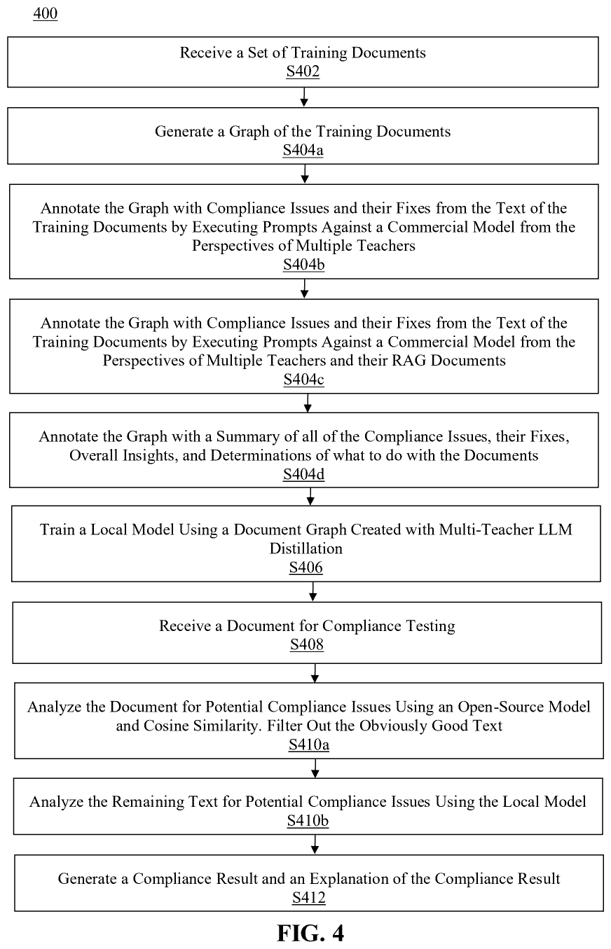

FIG. 4 illustrates a process 400 for generating a local model to assess compliance issues of provided documents and to provide a comprehensive explanation of the assessment, according to an embodiment.

In process 400 of FIG. 4, at step S402, the compliance review device 302 may access or receive at least one training document. The training document may be a sample document or a previously used document. The training document may be an advertisement or marketing document. The word document is not limited to a text document and may include all media (e.g., audio, video, images, etc.).

At step S404a, the compliance review device 302 may generate a document graph. At step S404b, the compliance review device 302 may annotate the document graph with compliance issues and their fixes from the text of the training documents by executing prompts against a commercial model from the perspectives of multiple teachers (e.g., compliance officer, marketing officer, regulator, client, etc.). At step S404c, the compliance review device 302 may also annotate the document graph with compliance issues and their fixes from the text of the training documents by executing prompts against a commercial model from the perspectives of multiple teachers and their Retrieval Augmented Generation (RAG) documents. At step S404d, the compliance review device 302 may annotate the graph with a summary of all of the compliance issues, their fixes, overall insights, and determinations of what to do with the document.

For example, the compliance review device 302 may use an LLM distillation teacher student process, in which the commercial model (e.g., LLM) may be prompted to determine the compliance of a training document based on a certain perspective, as well as certain policies, rules, and/or regulations. The commercial model may be a general-purpose AI-based model (e.g., ChatGPT). The prompt may include a selected perspective for which the commercial model is instructed to analyze the training document from. In an embodiment, the perspective may include at least one from among a compliance officer perspective, a marketing officer perspective, a regulator perspective, and a client perspective. In some embodiments, the policies, rules, and/or regulations may include at least one from among a compliance policy, a compliance procedure manual, an audit report, a marketing document guideline, a marketing procedure manual, a marketing training manual, a regulations document, a regulator findings document, a client complaint, a client account disclosure, a compliance taxonomy, a marketing taxonomy, a regulator taxonomy, and a client taxonomy. For example, according to an embodiment, the document graph may be generated by prompting the commercial model to determine the compliance of a sample marketing document from the perspective of a compliance officer based only on a provided compliance policy and a provided compliance procedure manual. The resulting output from the commercial model may then be used as input to the document graph. In an embodiment, the commercial model may be run or executed multiple times, each time having a different prompt using different perspectives, policies, rules, and/or regulations. Each resulting output from the commercial model may then be used as input for the document graph. In an embodiment, when incremental new data (e.g., rules, policies, standards, etc.) is received, the document graph may be re-generated by repeating step S404.

In an embodiment the document graph may be generated by running model inference on the a commercial model using four agents, each with a prompt and RAG data that gives the agent a unique perspective and is based upon the RAG data, and running another model inference on the a commercial model using the four respective agents, each with the previous respective prompt that gives each respective agent a unique perspective but is based upon public data. The four unique perspectives may include a compliance officer, a marketing officer, a regulator, and a client.

At step S406, the compliance review device 302 may train a local model using the generated document graph. The local model may be an in-house generated AI model. In an embodiment, the local model may only rely on the information from within the document graph for performing its analysis. In an embodiment, the local model may be further trained on organization-specific data. For example, the local model may be trained to analyze documents based on the specific organizations own internal policies, rules, and regulations. Thus, the local model may be fine-tuned on the results and explanations in the generated document graph. In an embodiment, when new data (e.g., rules, policies, standards, etc.) is received, they may be added to the document graph for re-training the local model.

At step S408, the compliance review device 302 may receive a document that needs to be evaluated for compliance issues. The document may be an advertisement or marketing document. The document may require compliance testing prior to being published or made publicly available. The word document is not limited to a text document and may include all media (e.g., audio, video, images, etc.).

At step S410a, the compliance review device 302 may analyze the document for compliance issues using an open-source model and cosine similarity analysis. The analysis at step S410a may also filter out the obviously good text in order to save time and processing power required for further analyzing the document for compliance issues. At S410b, the compliance review device 302 may analyze the remaining text for potential compliance issues using the local model. The analysis may be based on the document graph. The analysis may be based solely on the policies, rules, and/or regulations, and in view of the perspectives used for generating the document graph and training the local model. For example, the compliance review device 302 may use the local model to determine if the marketing document is in compliance with a marketing document guideline, a marketing procedure manual, and a marketing training manual, from the perspective of a marketing officer. In some embodiments, the compliance review device 302 may separate the document into sub-document chunks. The sub-document chunks may be based on the number of words. The compliance review device 302 may then use an LLM to generate a respective embedding for each respective sub-document chunk. The compliance review device 302 may transmit each respective embedding to a vector database. Then, the compliance review device 302 may use an NLP and the local model to identify non-compliant phrases within each respective embedding in the vector database.

In an embodiment, the analyzing of the document for compliance issues may include checking for missing or incorrect disclaimers. For example, the compliance review device 302 may use an NLP to determine which disclaimers are required for a document. The compliance review device 302 may also use an NLP to search for the exact required language and flag documents with missing or incorrect language. In some embodiments, the analyzing of the document for compliance issues may include a preparation process for finding non-compliant wording in the document. For example, the compliance review device 302 may chunk the documents to be checked, create embeddings for the chunks using an open source LLM, and then save the embeddings in a vector database (e.g., Amazon Web Services (AWS) Open Search). Then, the compliance review device 302 may use the vector database to check for exact matches on non-compliant phrases. For example, the compliance review device 302 may use an NLP to identify exact matches on the search phrase within a document and report the matches.

In an embodiment, the compliance review device 302 may check for a fuzzy match on non-compliant phrases using a standard algorithm. For example, the compliance review device 302 may use Levenshtein edit distance, Jaccard index, and/or Jaro-Winkler distance algorithms to identify fuzzy matches within the document and report them. These algorithms may help detect sentences with minor spelling variations. For instance, the words “realise gains” and “realize gains” may both indicate non-compliance. An exact match would not identify these variations, but a fuzzy match would. In some embodiments, the compliance review device 302 may check for proximity matches on non-compliant phrases using NLP. Particularly, the compliance review device 302 may use an NLP to identify if the non-compliant search words are present a few words apart in the document and report the matches. This may ensure that even if the exact words are not there, the proximity of the words can be captured and checked for compliance. For example, Eliminate FOLLOWEDBY,2 tax would identify all sentences where the word eliminate is followed by tax with at least 2 words in between. This would capture a range of non-compliant sentences like eliminate payment of tax or eliminate high tax, etc.

In an embodiment, the compliance review device 302 may check for semantic matches on non-compliant phrases using cosine similarity. For example, the checking may be performed using the following steps. Step 1) use Cosine Similarity to compare the search phrase to each embedding in the document. Step 2) if a cosine similarity score surpasses a relatively low threshold, send the embedding to the next step. The low threshold eliminates most text, but the threshold still casts a wide net to include all potential matches. Step 3) transfer the search phrase, the text identified by a text embedding model (e.g., InstructorXL), and a few examples to the local LLM and prompt the LLM to do the following: a) categorize the text into one of three categories: i) true compliance issue; ii) non-issue; and iii) cannot confidently determine (i.e., a commercial model should make the determination). b) Generate an explanation for the categorization. c) If category i or ii, then the process is done, else pass category iii results to the next step. Step 4) transfer the search phrase, the text identified by the text embedding model, the few examples, and the local model explanation to the commercial model to do the following: a) categorize the text into one of three categories: i) true compliance issue; ii) non-issue; and iii) cannot confidently determine (i.e., a reviewer should make the determination). b) Generate an explanation for the categorization. c) If category i or ii, then the process is done, else pass category iii results to a reviewer as a last resort. Step 5) the reviewer reviews the text identified and determines whether it represents a compliance issue. This info is saved for future fine tuning of the local model.

In an embodiment, the compliance review device 302 may check for alignment with a compliance policy document using RAG by performing the following steps. Step 1) chunk the compliance policies that the documents must align with. Step 2) create embeddings for the chunks using an open source LLM (e.g., InstructorXL). Step 3) save the embeddings in a Vector DB (e.g., AWS Open Search). Step 4) use RAG and the local model: prompt the local model to search for document chunks that do not comply with policy chunks and categorize the text into one of three categories: i) true compliance issue; ii) non-issue; iii) cannot confidently determine (i.e., a commercial model should make the determination). Step 5) use RAG and a commercial model: pass the undetermined text in prompts to the commercial model to search for document chunks that don't comply with policy chunks and do the following: a) categorize the text into one of three categories: i) true compliance issue; ii) non-issue; and iii) cannot confidently determine (a reviewer should make the determination). b) Generate an explanation for the categorization. Step 6) if category i or ii, then the process is done, else transfer category iii results to a reviewer as a last resort.

In an embodiment, the compliance review device 302 may check for alignment with regulations with RAG. For example, the compliance review device 302 may follow the same RAG process as used for compliance polices but instead use regulation documents, such as regulations and regulator findings. In some embodiments, the compliance review device 302 may check for alignment with regulations with a general prompt. For example, the compliance review device 302 may prompt the local model to check the document chunks for anything that is not aligned with regulations based upon what the model knows from its training. In the prompt, the compliance review device 302 may ask for an explanation. The compliance review device 302 may not use a commercial model for this step. The compliance review device 302 may then prompt a commercial model to check if it agrees with the local model determinations. The commercial model may also be prompted to remove any false positives and to clean up the explanations.

In an embodiment, the compliance review device 302 may check for alignment with common values (i.e., to protect an organization's reputation with RAG). For example, the compliance review device 302 may follow the same RAG process as used for compliance polices but instead use client RAG documents such as client complaints and client account disclosures. In some embodiments, the compliance review device 302 may check for alignment to protect an organization's reputation with a general prompt. For example, the compliance review device 302 may prompt the local model to check the document chunks for anything that is not aligned with regulations based upon what the model knows from its training. The prompt may ask for an explanation. A commercial model may not be used for this step. Next, the compliance review device 302 may then prompt a commercial model to check if it agrees with the local model determinations. The commercial model may also be prompted to remove any false positives and to clean up the explanations.

In an embodiment, the compliance review device 302 may fine tune the local model on a dynamic schedule that maximizes ROI. Fine tuning and augmenting the training of a model with additional data is expensive relative to model inference, so fine tuning may only be performed if the benefits outweigh the costs. Furthermore, rather than schedule fine-tuning on the typical periodic basis, fine tuning may be dynamically scheduled to maximize ROI. At a high-level, fine tuning may occur when there is a regulatory reason that requires fine-tuning and the benefit is larger than cost, such that waiting longer to fine tune will decrease ROI. The decision to fine tune may be automated using the following ROI maximizing process: 1) model performance monitoring; 2) automate trigger condition to maximize ROI and fine tune; 3) cost benefit analysis; 4) decision-making to fine tune and maximize ROI; and 5) fine tuning execution.

The model performance monitoring may include automated key performance indicator (KPI) tracking and anomaly detection. For example, automated KPI tracking may include implementing automated systems to continuously monitor and KPIs, such as accuracy, precision, recall, and F1 score. Anomaly detection may include utilizing machine learning algorithms to detect anomalies in model performance and triggering alerts when performance deviates from expected ranges. Anomaly detection may also include using predefined formulas such as Z-score to identify significant deviations. For example, Z=(X−μ)/σ, where X is the current performance metric, μ is the mean performance, and σ is the standard deviation.

The automating of a trigger condition to maximize ROI and fine tune may be based on a regulatory change detection, a data quality assessment, KPI dropping below a predefined threshold, and a periodic review based on model risk and impact/value. Regulatory change detection may include integrating automated systems to monitor regulatory updates and changes. Regulatory change detection may also include using NLP to parse and understand new regulations that may impact model performance. Data quality assessment may include automating the assessment of new training data quality. Data quality assessment may also include using algorithms to evaluate data relevance, accuracy, and completeness before considering it for fine-tuning. For example, the data quality assessment may be based on calculating the data quality score (DQS): DQS=(Number of Valid Entries)/(Total Number of Entries).

The cost-benefit analysis may be based on a real-time cost estimation and a benefit quantification. The real-time cost estimation may include developing automated tools to estimate the real-time cost of fine-tuning, including computational resources, labor, and regulatory risk. For example, calculating the cost (C) as: [C={cost_compute}+{cost_labor}], where {cost_compute} is the cost of computational resources and {cost_labor} is the cost of labor. The benefit quantification may include automating the process of translating performance improvements into financial terms and using historical data to model the financial impact of performance changes. The cost-benefit analysis may include determining the value of the current solution (without fine tuning) with the following parameters: V=(Δ{TP}×{V_TP})+(Δ{TN}×{V_TN})−(Δ{FP}×{V_FP})−(Δ{FN}×{V_FN}), where (TP) is the total performance metric, (V_TP) is the value of the total performance metric, (TN) is the performance metric of the selected solution (N), (V_TN) is the value of the performance metric of the selected solution (N), (FP) is the improvement of performance, (V_FP) is the value of the improvement of performance, (FN) is the improvement of the selected solution (N), and (V_FN) is the is the value of the improvement of the selected solution (N). The benefit (B) may be calculated as: B=ΔP×V, where (ΔP) is the improvement in performance metrics and (V) is the financial value of the improvement.

The cost-benefit analysis may further be based on a periodic evaluation of decision criteria. The periodic evaluation of decision criteria may include estimating the potential impact of delaying fine-tuning on compliance and operational efficiency by the following steps. Step 1) define objectives and metrics by establishing a threshold for fine tuning. Step 2) create a synthetic dataset of new data. Step 3) select the current baseline model. Step 4) define fine-tuning scenarios by creating multiple fine-tuning scenarios by varying parameters such as the amount of new data, learning rates, batch sizes, and epochs. Step 5) run simulations. Step 6) analyze results using three different scenarios: scenario 1: (ΔF=0.02); scenario 2: (ΔF=0.03); and scenario 3: (ΔF=0.025). Step 7) estimate potential improvement by averaging improvement using: (ΔF_{{avg}}=(0.02+0.03+0.025)/3=0.025). And step 8) decision criterion: if (B×ΔF_{{avg}}>C), proceed with fine-tuning where B is the benefit and C is the cost.

The decision-making to fine tune and maximize ROI may be based on an ROI calculation and a threshold-based decision engine. The ROI calculation may implement automated systems to calculate the expected ROI of fine-tuning based on real-time cost and benefit data. For example: ROI=(Benefit−Cost)/Cost. The threshold-based decision engine may use predefined ROI thresholds to automatically decide whether to proceed with fine-tuning. This engine may consider the urgency and potential impact of delays.

The fine-tuning execution may include automated fine-tuning pipelines, resource allocation, and a post-fine-tuning evaluation. The automated fine-tuning pipelines may be created for the fine-tuning process. These pipelines may manage data preprocessing, model training, validation, and deployment with minimal human intervention. The resource allocation may include using automated resource management systems to allocate computational resources efficiently, scaling up or down based on the fine-tuning requirements. For example, by using the following cost function to optimize resource allocation:

$$[ {C}_{\{ r e s o u r c e \}} = min ( {\sum }_{{\{ i = 1 \}}^{\{ n \}}} {R}_{i} \times {C}_{i} ) ]$$

where (Ri) is the resource requirement and (Ci) is the cost per unit of resource (i). The post-fine-tuning evaluation may include a performance re-evaluation and a continuous feedback loop. The performance re-evaluation may include automating the re-evaluation of model performance post-fine-tuning and using the same KPIs and anomaly detection systems to ensure the expected benefits are realized. The continuous feedback loop may be implemented so that insights from each fine-tuning cycle are automatically fed back into the system to refine future cost-benefit analyses and decision-making processes.

The above-described fine-tuning process may ensure that organizations can optimize the ROI of fine-tuning activities, ensuring that resources are used efficiently, and performance improvements are maximized.

At step S412, the compliance review device 302 may generate a compliance result based on the analysis of the document for compliance issues. The compliance review device 302 may also explain the reasoning for the compliance result. For example, the compliance review device 302 may output to a display or graphical user interface (GUI) that the marketing document is not compliant because it contains a statement that may be interpreted as guaranteeing performance, which is against the compliance policy. In an embodiment, the output may include at least one from among a flagged text that represents a potential compliance issue, an explanation of what is non-compliant about the flagged text, proposed copy edits to make the flagged text compliant, an explanation of the proposed copy edit, and a proposed next step to be taken. For example, the compliance review device 302 may highlight or flag a section of the marketing document that guarantees performance. The output may also contain overall insights on the document findings, fixes, and next steps. For example, the output may include a text display stating that the document had certain issues from the perspective of Party A that have been fixed and it makes sense to send the fixed document to clients. The compliance review device 302 may then output or display a text box explaining that this portion is not compliant because it guarantees performance, which is against the compliance policy. Next, the compliance review device 302 may propose removing the highlighted section because it is the only portion of the document that is non-compliant and that by removing that section, the marketing document would then be compliant.

In an embodiment, the compliance result may categorize the document as being at least one from among a true compliance issue, a non-issue, and an undetermined result. When the compliance result is categorized as being an undetermined result, the compliance review device 302 may re-analyze the document for compliance issues using a commercial model.

In some embodiments, the compliance review device 302 may use a machine learning algorithm to analyze the performance of the local model and determine whether any anomalies occur in the results. The anomalies may include inaccurate or imprecise determinations and/or explanations of compliance issues. When anomalies are detected in the local model, the compliance review device 302 may trigger a tuning of the local model based on the anomaly detection. In an embodiment, the compliance review device 302 may determine that the local model needs to be completely re-trained and may restart the process 400 at step S402. In an embodiment, the compliance review device 302 may assess the performance of the local model by performing an ROI analysis. The ROI analysis may include determining a performance metric value and a cost-benefit metric value of the local model. The tuning of the local model may be based on the results of the ROI analysis.

The compliance review device 302 may minimize the cost and increases performance, accuracy, and reliability. The compliance review device 302 may create a local model that is free to use and faster, more reliable, lower cost to run, and more accurate than other document processing products. The compliance review device 302 may use a commercial model (teacher) to create training data for fine tuning an open-source model (student). Through this teacher-student method, the compliance review device 302 may use a free model that produces results like a commercial model. The local model may be fined tuned with a mixture-of-experts process. The process may use RAG, from the perspectives of multiple LLM agents. The result may be that the local student model is more accurate than previous one-dimensional solutions, or any one of its teachers. The model may run locally, not via an API, thus removing latency and dramatically improving performance. Unlike an external APIs, the local model may be fully controlled so the LLM weights never change, making the compliance review device 302 more reliable than other solutions. The compliance review device 302 may use an open-source model that is smaller than the commercial model, so it runs faster and uses less costly compute power.

The compliance review device 302 may minimize the use of LLM, and especially the use of commercial LLMs, when running inference. The compliance review device 302 may segment inference jobs by complexity and apply the cheapest, and most accurate tool for the job. For example, the compliance review device 302 may use NLP to ensure that required environmental, social, and governance (ESG) language and diversity, equity, and inclusion (DEI) language is included and precise. The compliance review device 302 may use the latest commercial LLM to verify that text and media will not tarnish the organization's reputation. The compliance review device 302 may run inference first with the local model to reduce the problem space. Then, if needed, run the latest commercial LLM only on curated data for the best results. In other words, the compliance review device 302 may do most of the model inference work with free tools and polish the work with accurate commercial LLMs on an as needed basis. The compliance review device 302 may limit the document search space so that less processing power is required. This may be done by leveraging a vector database (e.g., AWS Open Search) that has meta-data tags for the topic and sub-topic of each embedding saved in the vector DB.

The compliance review device 302 may minimize the cost of fine-tuning maintenance. The compliance review device 302 may perform fine-tuning maintenance only when the benefit exceeds cost and maximizes ROI. The compliance review device 302 may minimize the use of commercial models when fine tuning.

The compliance review device 302 may find more compliance issues than other commercial tools. Because the compliance review device 302 needs costly commercial LLMs for a relatively small portion of its process, the compliance review device 302 can afford to apply commercial LLM power to more documents, websites, and videos than other automated solutions. Thus, the compliance review device 302 may find more compliance issues because it is acceptably economical for it to check more documents. The compliance review device 302 may check for a wider range of issues than other automated solutions. The compliance review device 302 may check for things that are on the internet, but that the organization is unaware of. This may position the compliance review device 302 to know more than any organization employee and identify compliance issues that no organization compliance officer is aware of.

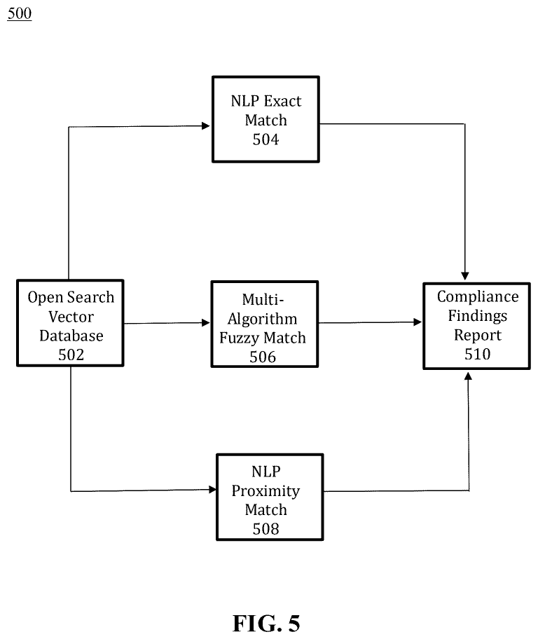

FIG. 5 illustrates a system diagram 500 for generating a local model to assess compliance issues of provided documents and to provide a comprehensive explanation of the assessment, according to an embodiment.

FIG. 5 shows an open search vector database 502 that provides data to an NLP exact match module 504, a multi-algorithm fuzzy match module 506, and an NLP proximity match module 508. Each of these modules analyzes the provided data, as further described above in relation to step S410, to determine if there are any compliance issues with the provided data. The results from the analyses are then transferred to the compliance findings report module 510 for generating a compliance result, as further described above in relation to step S412.

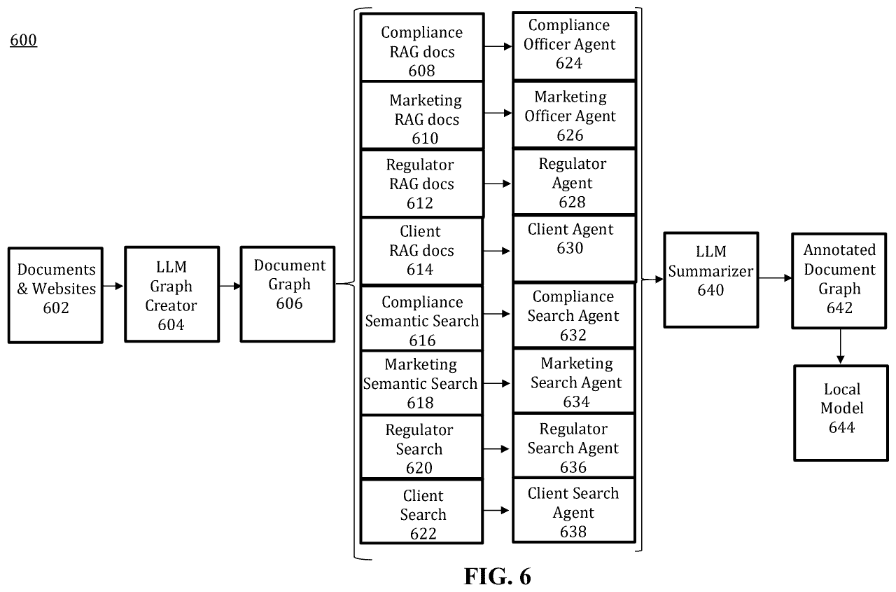

FIG. 6 illustrates a flow diagram 600 of a process for generating a local model to assess compliance issues of provided documents and to provide a comprehensive explanation of the assessment, according to an embodiment.

FIG. 6 shows a documents and websites module 602 that contains various marketing or advertisement material that need to be checked for compliance issues. The documents are transmitted to an LLM graph creator 604. The LLM graph creator 604 may be a general-purpose AI model (e.g., ChatGPT). The LLM graph creator 604 generates a document graph 606. As illustrated in FIG. 6, the document graph 606 is generated based on eight different inputs having different input documents and perspectives. For example, as illustrated in FIG. 6, the first input, working from the top of the table down, is based on compliance RAG documents 608 that are analyzed in the perspective of a compliance officer agent 624. The compliance RAG documents 608 may include compliance policies, compliance procedure manuals, and audit reports. The second input is based on marketing RAG documents 610 analyzed in the perspective of a marketing officer agent 626. The marketing RAG documents 610 may include marketing document guidelines, marketing procedure manuals, and marketing training manuals. The third input is based on regulator RAG documents 612 analyzed in the perspective of a regulator officer agent 628. The regulator RAG documents 612 may include regulations and regulator findings. The fourth input is based on client RAG documents 614 analyzed in the perspective of a client agent 630. The client RAG documents 614 may include client complaints and client account disclosures. The fifth input is based on a compliance semantic search 616 analyzed in the perspective of a compliance search agent 632. The compliance semantic search 616 may include a compliance taxonomy. The sixth input is based on a marketing semantic search 618 analyzed in the perspective of a marketing search agent 634. The marketing semantic search 618 may include a marketing taxonomy. The seventh input is based on a regulator search 620 analyzed in the perspective of a regulator search agent 636. The regulator search 620 may include a regulator taxonomy. The eighth input is based on a client search 622 analyzed in the perspective of a client search agent 638. The client search 622 may include a client taxonomy.

Next, the document graph 606 is analyzed by an LLM summarizer 640 to create an annotated document graph 642. The annotated document graph 642 contains the four perspectives and the overall insights from generating the document graph 606. The annotated document graph 642 is then used to train the local model 644.

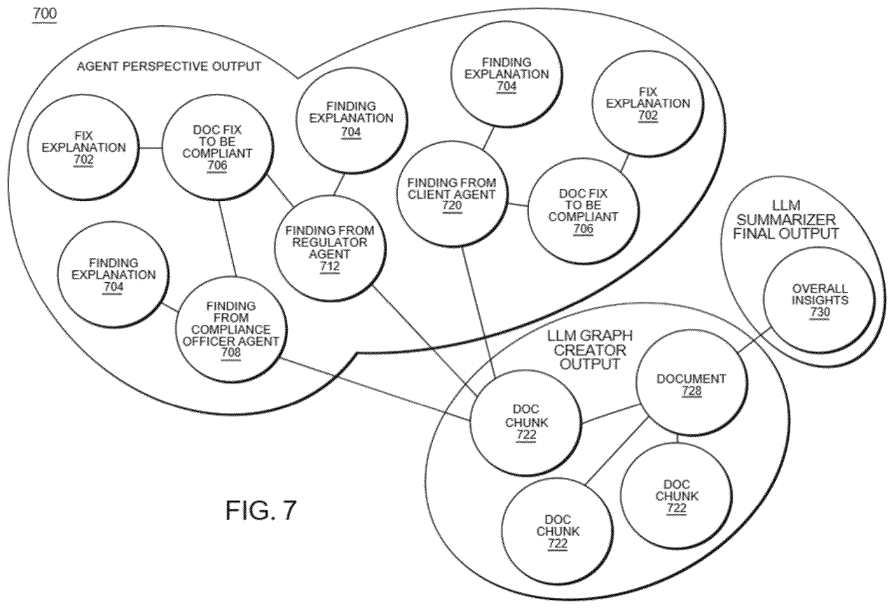

FIG. 7 illustrates a flow diagram of a process for generating a local model to assess compliance issues of provided documents and to provide a comprehensive explanation of the assessment, according to an embodiment.

As shown in FIG. 7, an agent perspective output is generated based on a finding from a compliance officer agent 708, a finding from a regulator agent 712, and a finding from a client agent 720. The finding from the compliance agent 708, the finding from a regulator agent 712, and the finding from a client agent 720 may each include a fix explanation 702, a finding explanation 704, and a document fix to be compliant 706. Each of the finding from the compliance agent 708, the finding from a regulator agent 712, and the finding from a client agent 720 may be used to generate a document chunk 722. A plurality of document chunks 722 compose a document 728 which is part of an LLM graph creator output. The document 728 is then used to provide overall insights 730, which are part of an LLM summarizer final output.

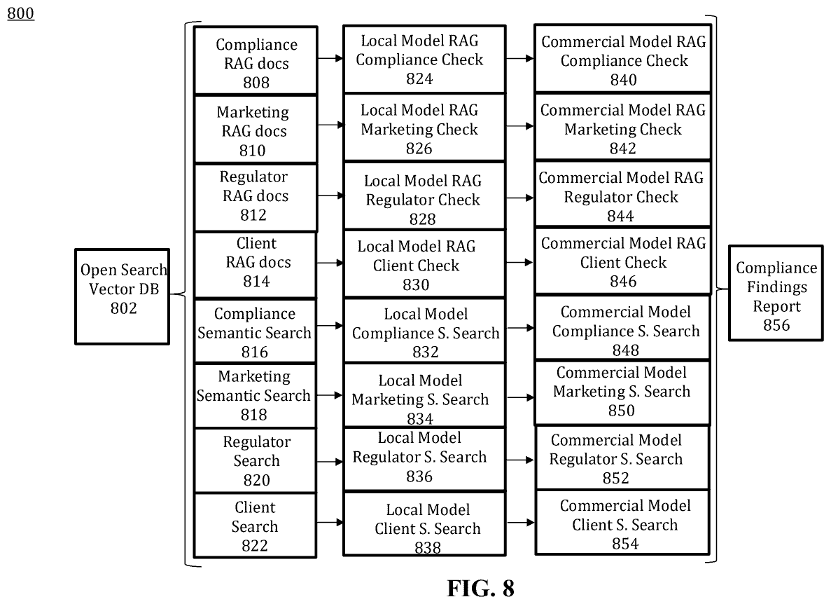

FIG. 8 illustrates a flow diagram 800 of a process for generating a local model to assess compliance issues of provided documents and to provide a comprehensive explanation of the assessment, according to an embodiment. Particularly, the flow diagram 800 illustrates a process in which a commercial model verifies local model results.

FIG. 8 shows an open search vector database 802 that is composed of eight different inputs that are based on different input documents and perspectives. For example, as illustrated in FIG. 8, the first input, working from the top of the table down, is based on compliance RAG documents 808 that are fed into the local model RAG compliance check module 824 for checking the compliance of a received document. The RAG documents 808 may include compliance policies, compliance procedure manuals, and audit reports. The results from the compliance check by the local model RAG compliance check module 824 are then analyzed and verified by the commercial model RAG compliance check module 840. The second input is based on marketing RAG documents 810 that are fed into the local model RAG marketing check module 826 for checking the compliance of the received document. The marketing RAG documents 810 may include marketing document guidelines, marketing procedure manuals, and marketing training manuals. The results from the compliance check by the local model RAG marketing check module 826 are then analyzed and verified by the commercial model RAG marketing check module 842. The third input is based on regulator RAG documents 812 that are fed into the local model RAG regulator check module 828 for checking the compliance of the received document. The regulator RAG documents 812 may include regulations and regulator findings. The results from the compliance check by the local model RAG regulator check module 828 are then analyzed and verified by the commercial model RAG regulator check module 844. The fourth input is based on client RAG documents 814 that are fed into the local model RAG client check module 830 for checking the compliance of the received document. The client RAG documents 814 may include client complaints and client account disclosures. The results from the compliance check by the local model RAG client check module 830 are then analyzed and verified by the commercial model RAG client check module 846. The fifth input is based on a compliance semantic search 816 that is fed into the local model RAG compliance semantic search module 832 for checking the compliance of the received document. The compliance semantic search 816 may include a compliance taxonomy. The results from the compliance check by the local model RAG compliance semantic search module 832 are then analyzed and verified by the commercial model RAG compliance semantic search module 848. The sixth input is based on a marketing semantic search 818 that is fed into the local model RAG marketing semantic search module 834 for checking the compliance of the received document. The marketing semantic search 818 may include a marketing taxonomy. The results from the compliance check by the local model RAG marketing semantic search module 834 are then analyzed and verified by the commercial model RAG marketing semantic search module 850. The seventh input is based on a regulator search 820 that is fed into the local model RAG regulator semantic search module 836 for checking the compliance of the received document. The regulator search 820 may include a regulator taxonomy. The results from the compliance check by the local model RAG regulator semantic search module 836 are then analyzed and verified by the commercial model RAG regulator semantic search module 852. The eighth input is based on a client search 822 that is fed into the local model RAG client semantic search module 838 for checking the compliance of the received document. The client search 822 may include a client taxonomy. The results from the compliance check by the local model RAG client semantic search module 838 are then analyzed and verified by the commercial model RAG client semantic search module 854. Each of these results are then used to generate the compliance findings report 856.

Accordingly, with this technology, an optimized process for generating a local model to assess compliance issues of provided documents and to provide a comprehensive explanation of the assessment is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing compliance reviews, the method being implemented by at least one processor, the method comprising:
receiving, by the at least one processor, at least one training document;
generating, by the at least one processor, a document graph that includes compliance issues and text fixes for the compliance issues by executing a plurality of prompts within a commercial model on the training document,
wherein each prompt of the plurality of prompts represents a respective perspective selected from among a plurality of perspectives,
wherein each prompt includes a respective selection of documents from among a plurality of documents, and
wherein the execution of each respective prompt generates a respective first output that is used as an input for the document graph;
training, by the at least one processor, a local model based on the document graph;
receiving, by the at least one processor, a first document for which compliance testing is requested;
analyzing, by the at least one processor via the local model, the first document for compliance issues; and
generating, by the at least one processor, a second output based on a result of the analyzing, wherein the second output includes at least one from among a compliance result of the first document, an explanation of the compliance result, and a fix for an identified compliance issue.

2. The method of claim 1, wherein the plurality of perspectives includes at least one from among a compliance officer perspective, a marketing officer perspective, a regulator perspective, and a client perspective, and wherein the training of the local model uses large language model (LLM) distillation.

3. The method of claim 1, wherein the plurality of documents includes at least one from among a compliance policy, a compliance procedure manual, an audit report, a marketing document guideline, a marketing procedure manual, a marketing training manual, a regulations document, a regulator findings document, a client complaint, a client account disclosure, a compliance taxonomy, a marketing taxonomy, a regulator taxonomy, and a client taxonomy.

4. The method of claim 1, wherein the respective first output includes at least one from among a flagged text that represents a potential compliance issue, an explanation of what is non-compliant about the flagged text, a proposed copy edit to make the flagged text compliant, an explanation of the proposed copy edit, and a proposed next step to be taken.

5. The method of claim 1, further comprising:
training, by the at least one processor, the local model on organization-specific data.

6. The method of claim 1, wherein the analyzing of the first document comprises:
separating, by the at least one processor, the first document into at least one sub-document chunk having a predetermined number of words;
generating, by the at least one processor via a large language model (LLM), a respective embedding for each respective sub-document chunk of the at least one sub-document chunk;
transmitting, by the at least one processor, each respective embedding to a vector database; and
identifying, by the at least one processor via a natural language processing (NLP) and the local model, non-compliant phrases within each respective embedding in the vector database.

7. The method of claim 1, further comprising:
categorizing, by the at least one processor, the compliance result of the first document as being at least one from among a true compliance issue, a non-issue, and an undetermined result; and
when the compliance result is categorized as being the undetermined result, analyzing, by the at least one processor via the commercial model, the first document for compliance issues.

8. The method of claim 1, further comprising:
determining, by the at least one processor via a machine learning algorithm, whether there is an anomaly in a performance of the local model; and
triggering, by the at least one processor, a tuning of the local model based on a result of the determining.

9. The method of claim 8, further comprising:
performing, by the at least one processor, a return on investment (ROI) analysis for the local model,
wherein the performing of the ROI analysis includes determining a performance metric value and a cost-benefit metric value, and
wherein the triggering of the tuning is further based on a result of the ROI analysis.

10. A computing apparatus for performing compliance reviews, the computing apparatus comprising:
a processor;
a memory; and
a communication interface coupled to each of the processor and the memory,
wherein the processor is configured to:
receive at least one training document;
generate a document graph that includes compliance issues and text fixes for the compliance issues by executing a plurality of prompts within a commercial model on the training document,
wherein each prompt of the plurality of prompts represents a respective perspective selected from among a plurality of perspectives,
wherein each prompt includes a respective selection of documents from among a plurality of documents, and
wherein the execution of each respective prompt generates a respective first output that is used as an input for the document graph;
train a local model based on the document graph;
receive a first document for which compliance testing is requested;
analyze, via the local model, the first document for compliance issues; and
generate a second output based on a result of the analyzing, wherein the second output includes at least one from among a compliance result of the first document, an explanation of the compliance result, and a fix for an identified compliance issue.

11. The computing apparatus of claim 10, wherein the plurality of perspectives includes at least one from among a compliance officer perspective, a marketing officer perspective, a regulator perspective, and a client perspective, and wherein the training of the local model uses large language model (LLM) distillation.

12. The computing apparatus of claim 10, wherein the plurality of documents includes at least one from among a compliance policy, a compliance procedure manual, an audit report, a marketing document guideline, a marketing procedure manual, a marketing training manual, a regulations document, a regulator findings document, a client complaint, a client account disclosure, a compliance taxonomy, a marketing taxonomy, a regulator taxonomy, and a client taxonomy.

13. The computing apparatus of claim 10, wherein the respective first output includes at least one from among a flagged text that represents a potential compliance issue, an explanation of what is non-compliant about the flagged text, a proposed copy edit to make the flagged text compliant, an explanation of the proposed copy edit, and a proposed next step to be taken.

14. The computing apparatus of claim 10, wherein the processor is further configured to train the local model on organization-specific data.

15. The computing apparatus of claim 10, wherein the processor is further configured to perform the analyzing of the first document by:
separating the first document into at least one sub-document chunk having a predetermined number of words;
generating, via a large language model (LLM), a respective embedding for each respective sub-document chunk of the at least one sub-document chunk;
transmitting each respective embedding to a vector database; and
identifying, via a natural language processing (NLP) and the local model, non-compliant phrases within each respective embedding in the vector database.

16. The computing apparatus of claim 10, wherein the processor is further configured to:
categorize the compliance result of the first document as being at least one from among a true compliance issue, a non-issue, and an undetermined result; and
when the compliance result is categorized as being the undetermined result, analyze, via the commercial model, the first document for compliance issues.

17. The computing apparatus of claim 10, wherein the processor is further configured to:
determine, via a machine learning algorithm, whether there is an anomaly in a performance of the local model; and
trigger a tuning of the local model based on a result of the determination.

18. The computing apparatus of claim 17, wherein the processor is further configured to:
perform a return on investment (ROI) analysis for the local model,
wherein the performing of the ROI analysis includes determining a performance metric value and a cost-benefit metric value, and
wherein the triggering of the tuning is further based on a result of the ROI analysis.

19. A non-transitory computer readable storage medium storing instructions for performing compliance reviews, the storage medium comprising executable code which, when executed by a processor, causes the processor to:
receive at least one training document;
generate a document graph that includes compliance issues and text fixes for the compliance issues by executing a plurality of prompts within a commercial model on the training document,
wherein each prompt of the plurality of prompts represents a respective perspective selected from among a plurality of perspectives,
wherein each prompt includes a respective selection of documents from among a plurality of documents, and
wherein the execution of each respective prompt generates a respective first output that is used as an input for the document graph;
train a local model based on the document graph;
receive a first document for which compliance testing is requested;
analyze, via the local model, the first document for compliance issues; and
generate a second output based on a result of the analyzing, wherein the second output includes at least one from among a compliance result of the first document, an explanation of the compliance result, and a fix for an identified compliance issue.

20. The storage medium of claim 19, wherein the plurality of perspectives includes at least one from among a compliance officer perspective, a marketing officer perspective, a regulator perspective, and a client perspective, and wherein the training of the local model uses large language model (LLM) distillation.
